(19) United States
(12) Patent Application Publication
(10) Pub. No.: US 2005/0202325 A1
(43) Pub. Date: Sep. 15, 2005

(54) Device for generating light and liquid crystal display apparatus having the same

(76) Inventors: Joong-Hyun Kim, Yongin-si (KR); Hyoung-Joo Kim, Euiwang-si (KR); Sang-Yu Lee, Yongin-si (KR); In-Sun Hwang, Suwon-si (KR); Jin-Seob Byun, Seoul (KR)

Correspondence Address: CANTOR COLBURN, LLP, 55 GRIFFIN ROAD SOUTH, BLOOMFIELD, CT, 06002, US

(21) Appl. No.: 11/063,514

(22) Filed: Feb. 23, 2005

(30) Foreign Application Priority Data
Mar. 15, 2004 (KR) 2004-17348

(51) Int. Cl. G03C 5/00

(52) U.S. Cl. 430/28

(57) ABSTRACT

A device for generating light capable of uniformly distributing discharge gases in discharge areas, as well as preventing charge drift. The device includes a first substrate, a second substrate assembled with the first substrate to form a discharge space between the first and second substrates. The second substrate includes at least one sinking portion extending toward the first substrate to divide the discharge space into at least two discharge areas, and at least one connection passage is formed on the first substrate to connect the discharge areas to each other.

### BACKGROUND OF THE INVENTION

1. Field of the Invention

The present invention relates to a device for generating light and a liquid crystal display (LCD) apparatus having the same, and more particularly, to a device for generating light capable of uniformly distributing discharge gases in discharge areas, as well as preventing charge drift, a LCD apparatus having the same, and a method for manufacturing the same.

2. Description of the Related Art

Liquid Crystal Display (LCD) apparatuses display images using the liquid crystals. Because LCD apparatuses have many advantages such as thinner, smaller, lower power consumption, higher resolution, among other thins, they are widely applied to electronic devices, including, laptop computers, monitors, mobile communications systems and the like.

LCD apparatuses include a LCD panel to display images and a backlight assembly to provide a light source for the liquid crystal display panel. Backlight assemblies generally employ cold cathode fluorescent lamps (CCFLs) as light sources, and are classified as either edge type backlight assemblies or direct type backlight assemblies depending on the location of the light sources. Edge type backlight assemblies include a light source disposed on a side surface of a transparent light guide plate. The light generated from the light source is radially reflected through one surface of the transparent light guide plate, and provided to a LCD panel. Direct type backlight assemblies include a plurality of light sources disposed under a LCD panel, a diffusion plate disposed over the light sources, and a reflection plate disposed under the light sources. Both the direct type backlight assemblies and the edge type backlight assemblies have disadvantages including as low effectiveness due to the loss of the light source and poor brightness, as well as high manufacture cost due to a complicated structure.

Surface light source devices have been developed in order to solve the above enumerated disadvantages. Surface light source devices include a light source body having a plurality of discharge areas adjacent to each other and electrodes, disposed on the light source body, to apply discharge voltage to the light source body Each discharge area is communicated with adjacent discharge areas in order to uniformly distribute discharge gases. Plasma discharging occurs in each discharge area in response to the discharge voltages, thereby emitting light.

A drifting, however, may be generated in the surface light source devices due to cross-talk between the adjacent discharge areas, particularly, at an initial discharge. For example, electric charges may be concentrated in the discharge gas passage formed between adjacent discharge areas, and a discharge may be generated in only one discharge area of the adjacent discharge areas due to the charge drift. In this case, the surface light source devices may not emit light from the entire discharge areas.

### BRIEF SUMMARY OF THE INVENTION

The present invention provides a device for generating light capable of preventing charge drift as well as uniformly distributing discharge gases. The present invention further provides a liquid crystal display apparatus including the device for generating light. Still further, the present invention provides a method for manufacturing the device for generating light.

According to one aspect of the present invention, a device for generating light includes a first substrate; a second substrate assembled with the first substrate to form a discharge space between the first and second substrates, the second substrate including at least one sinking portion extending toward the first substrate to divide the discharge space into at least two discharge areas; and at least one connection passage formed on the first substrate to connect the discharge areas to each other.

According to another aspect of the present invention, a liquid crystal display apparatus includes a device for generating light including: a first substrate; a second substrate assembled with the first substrate to form a discharge space between the first and second substrates, the second substrate including at least one sinking portion extending toward the first substrate to divide the discharge space into at least two discharge areas; and at least one connection passage formed on the first substrate to connect the discharge areas to each other; a receiving container to receive the device for generating light; and a liquid crystal display panel to display an image in response to light emitted from the device for generating light.

According to a further aspect of the present invention, a method for manufacturing a device for generating light includes forming a first substrate; forming a second substrate including at least one sinking portion; adhering the first and second substrates at peripheral facing surfaces of the first and second substrates, wherein the at least one sinking portion extends toward the first substrate forming at least two discharge areas between the first and second substrates; and forming a connection passage on the first substrate to connect the at least two discharge areas to each other.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a device for generating light, according to an exemplary embodiment of the present invention;

FIG. 2 is a cross-sectional view of the device shown in FIG. 1;

FIG. 3 is a perspective view showing the lower film shown in FIG. 1;

FIG. 4 is a cross-sectional view taken along the line A-A′ of FIG. 3;

FIG. 5 is a cross-section view showing the lower film shown in FIG. 1 according to another exemplary embodiment of the present invention;

FIGS. 6 and 7 are perspective views showing the lower film shown in FIG. 1 according to alternative exemplary embodiments of the present invention;

FIG. 8 is an enlarged view of a portion “B” shown in FIG. 7;

FIG. 9 is a perspective view showing the lower film shown in FIG. 1 according to another exemplary embodiment of the present invention;

FIG. 10 is a cross-sectional view of the lower film shown in FIG. 9; and

FIG. 11 is an exploded perspective view of a liquid crystal display apparatus according to another exemplary embodiment of the present invention.

### DETAILED DESCRIPTION OF THE INVENTION

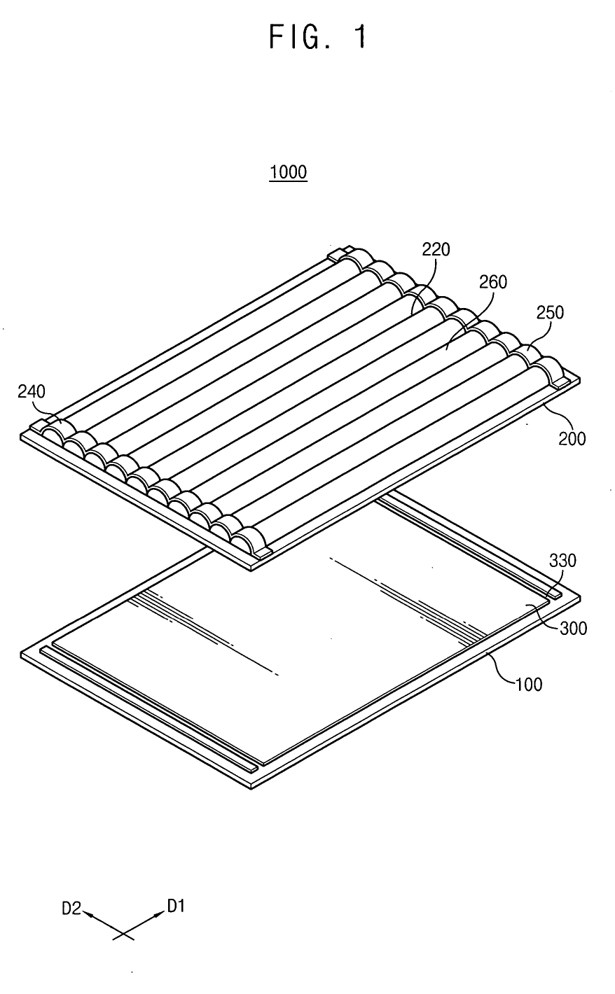

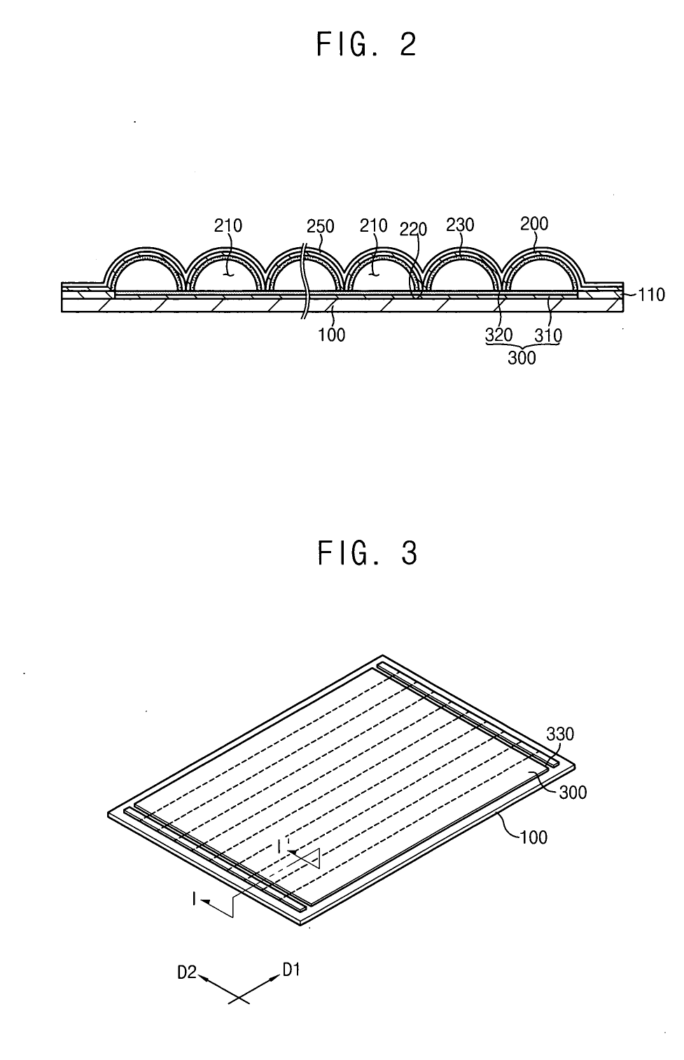

FIG. 1 is an exploded perspective view showing a device for generating light, according to an exemplary embodiment of the present invention. FIG. 2 is a cross-sectional view showing the assembled structure of the device of FIG. 1. Referring to FIGS. 1 and 2, a device for generating light 1000 includes a first substrate 100 and a second substrate 200 assembled with the first substrate 100 defining a discharge space. The device 1000 may include, for example, a surface light source device.

The first substrate 100 is a flat and substantially rectangular shape. For example, the first substrate 100 is a glass substrate that transmits visual rays but blocks ultraviolet rays. A lower film 300 is formed on the first substrate 100. The second substrate 200 includes, for example, a glass substrate assembled with the first substrate 100 to define the discharge space.

The second substrate 200 is manufactured with, for example, at least two forming shapes 260. For example, the second substrate 200 is formed by heating a plate glass substrate at a predetermined temperature and molding the glass substrate defining the forming shapes 260 on the glass substrate as depicted in FIG. 1. Alternatively, the second substrate 200 may be formed by heating a plate glass substrate at a predetermined temperature, placing the heated glass substrate on the vacuum mold having at least two forming shaped discharge areas, and vacuum adsorption of the glass substrate to the vacuum mold. At least one sinking portion 220 is formed between contiguous forming shapes 260. FIG. 1 shows the second substrate 200 having a plurality of the sinking portions 220 arranged with a predetermined space therebetween and each extending in a first direction D1. The second substrate 200 is assembled with the first substrate 100 such that the sinking portions 220 extend toward the lower film 300 of the first substrate 100. Referring to FIG. 2, the cross-section of the second substrate 200 has consecutively connected hemisphere shapes, but the vertical cross-section of the second substrate 200 may have consecutively connected trapezoid shapes, arched shapes or rectangular shapes.

The second substrate 200 is assembled with the first substrate 100 by an adhesive 110. The adhesive 110 includes, for example, a melted lead-glass, and adheres the first and second substrates 100 and 200 at the outboard peripheral facing surfaces of the first and second substrates 100 and 200. For example, the adhesive 110 is placed and fired at the peripheral facing surfaces of the first and second substrates 100 and 200. By adhering the first and second substrates 100 and 200 at the peripheral facing surfaces thereof, the discharge space is defined between the forming shapes 260 of the second substrate 200 and the lower film 300 of the first substrate 100.

Since the adhesive 110 is formed only at the peripheral facing surfaces of the first and second substrates 100 and 200 and the sinking portions 220 extend toward the lower film 300 of the first substrate 100, the sinking portions 220 are adhered to the lower film 300 of the first substrate 100 by a pressure difference between an inside and outside of the device 1000. Particularly, the discharge gases received in the discharge space between the forming shapes 260 of the second substrate 200 and the first substrate 100 have a pressure of, for example, about 50 torr which is different from an outside pressure, for example, about 70 torr, of the device 1000. Thus, the pressure difference between the inside and outside of the device 100 makes the sinking portions 220 adhered to the lower film 300, thereby dividing the discharge space into at least two discharge areas 210.

The lower film 300 acts as a buffer between the sinking portions 220 and the first substrate 100, and thus any damage that may occur by the adhesion is prevented. The lower film 300 is formed on an entire surface of the first substrate 100 except on the peripheral facing surface thereof, on which the adhesive 110 is disposed.

The first substrate 100 further includes a reflection layer 310 formed on the first substrate 100, a first fluorescent layer 320 formed on the reflection layer 310, and at least one connection passage 330 to connect the discharge areas 210 to each other. The reflection layer 310 reflects the light incident to the first substrate 100 toward the second substrate 200, and the first fluorescent layer 320 emits a visible ray in response to an invisible ray generated by a plasma discharge. A second fluorescent layer 230 is formed on an inner side of the second substrate 200 to emit the visible ray. A protection layer (not shown) may be formed between the second substrate 200 and the second fluorescent layer 230 to prevent a chemical reaction between the discharge gases, for example, mercury (Hg), and the second substrate 200.

The at least one connection passage 330 is formed to cross the sinking portions 220. The adjacent discharge areas 210 are communicated to each other through the connection passage 330. The connection passage 330 is formed by partially removing the lower film 300 or controlling the deposition thickness of the lower film 300. For example, a portion of the lower film 300 is removed to form the connection passage 330 having a predetermined width, or a portion of the lower film 330 is deposited to have a less thickness than that of the other portions of the lower film 300. When the connection passage 330 has a thinner deposition thickness than that of the other portions of the lower film 300, the connection passage 330 has a minimum size, thereby preventing charge drift between the adjacent discharge areas 210. Thus, the discharge gases are uniformly distributed in the discharge areas 210 through the connection passage 330 without generating charge drift.

The device for generating light 1000 further includes first and second electrodes 240 and 250 to receive a discharge voltage applied from an outside. The first and second electrodes 240 and 250 are each formed on both ends of an outside surface of the second substrate 200, and extend in a second direction D2 substantially perpendicular to the first direction D1. The first and second electrodes 240 and 250 each include a conductive material, for example, a copper, a nickel, an aluminum tape or a silver paste, and have a suitable surface area to receive an excitation energy. The first and second electrodes 240 and 250 are disposed on a non-effective emitting area of the second substrate 200, which overlaps an area of the first substrate 100 on which the connection passage 330 is formed. The first and second electrodes 240 and 250 may be disposed on at least one of the ends of the outer surface of the second substrate 200, the ends of the outer surface of the first substrate 100, or both ends of the outer surfaces of the first and second substrates 100 and 200.

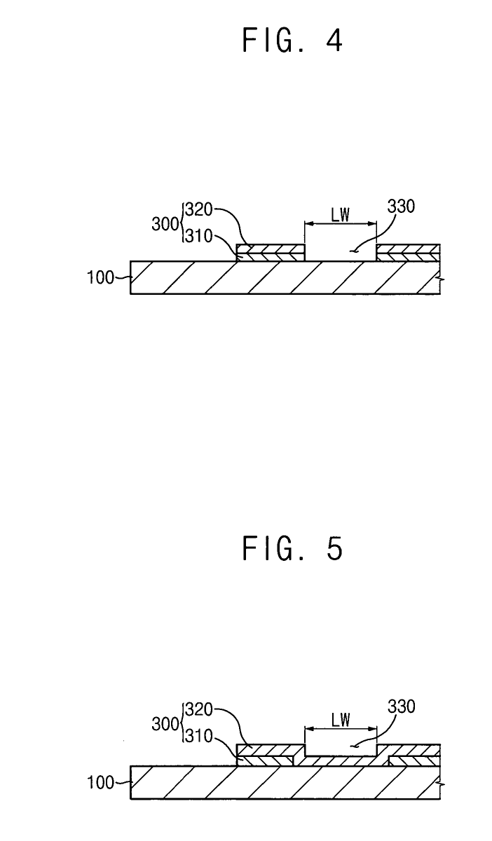

FIG. 3 is a perspective view showing the lower film 300 shown in FIG. 1, FIG. 4 is a cross-sectional view taken along the line A-A′ of FIG. 3, and FIG. 5 is a cross-section view showing the lower film shown in FIG. 1 according to another exemplary embodiment of the present invention. In FIG. 3, the dotted line represents the locations on which the sinking portions 220 are adhered.

Referring to FIGS. 3 and 4, the lower film 300 is formed on the first substrate 100 except on areas on which the adhesive 110 and the connection passage 330 are formed. The connection passage 330 has a linear shape having a predetermined width (LW) crossing all the sinking portions 220 and extending in the second direction D2 substantially perpendicular to the first direction D1, or substantially to the longitudinal direction defining the sinking portions 220. For example, the line width (LW) of the connection passage 330 is about 0.5 mm to about 1 mm. The connection passage 330 may be formed by removing a predetermined portion of the lower film 300 corresponding to the areas on which the ends defining the sinking portions 220 are located (FIG. 4) or by controlling the deposition thickness of the lower film 300 such that the portions of the lower film 300 corresponding to the areas on which the ends defining the sinking portions 220 are located have a thinner deposition thickness than the other portions of the lower film 300 (FIG. 5).

Still referring to FIG. 4, the reflection layer 310 is formed on an entire surface of the first substrate 100 except on the areas on which the adhesive 110 is deposited and the first fluorescent layer 320 is formed on the reflection layer 310. Then, a portion of the reflection layer 310 and the first fluorescent layer 320 corresponding to the areas on which at least one of the ends defining the sinking portions 220 is located are removed to form the connection passage 330. In this case, in which both the reflection layer 310 and the first fluorescent layer 320 are removed, the connection passage 330 is formed to overlap the non-effective emitting areas of the second substrate 200 on which the first or second electrode 240 or 250 is disposed.

Referring to FIG. 5, the reflection layer 310 is formed on the first substrate 100 except on the areas on which the adhesive 110 is disposed and the areas on which the connection passage 330 is formed. The first fluorescent layer 320 is formed on the reflection layer 310 and on the areas on which the connection passage 330 is formed. Alternatively, the reflection layer 310 is formed on the entire surface of the first substrate 100 except on the areas on which the adhesive 110 is disposed. The reflection layer 310 is removed from the areas on which the connection passage 330 is formed, and then the first fluorescent layer 320 is formed on the reflection layer 310 and on the areas on which the connection passage 330 is formed. In this case, the connection passage 330 is formed on the first substrate 100 on which the first fluorescent layer 320 is disposed preventing the formation of any black portion.

Because the reflection layer 310, in FIG. 5, is not formed on the areas corresponding to the connection passage 330, the first fluorescent layer 320 makes contact with the first substrate 100 and the connection passage 330 is formed on the area on which only the first fluorescent layer 320 is formed on the first substrate 100. The connection passage 330 has a thickness identical to the thickness of the lower film 300 from which the thickness of the reflection layer 310 is subtracted. For example, if the reflection layer 310 has a thickness of 80 μm and the first fluorescent layer 320 has a thickness of 80 μm, the lower film 300 has a thickness of 160 μm and the connection passage 330 has a thickness of 80 μm. If the line width (LW) of the connection passage 330 is about 1 mm, the connection passage 330 has a surface area of 0.08 mm×1 mm.

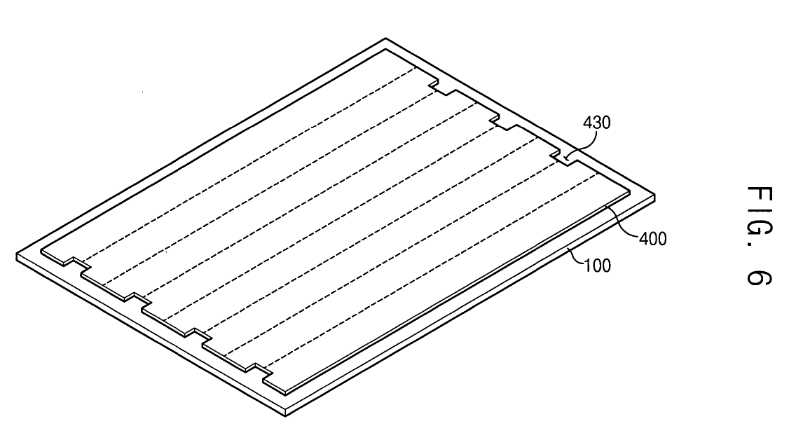

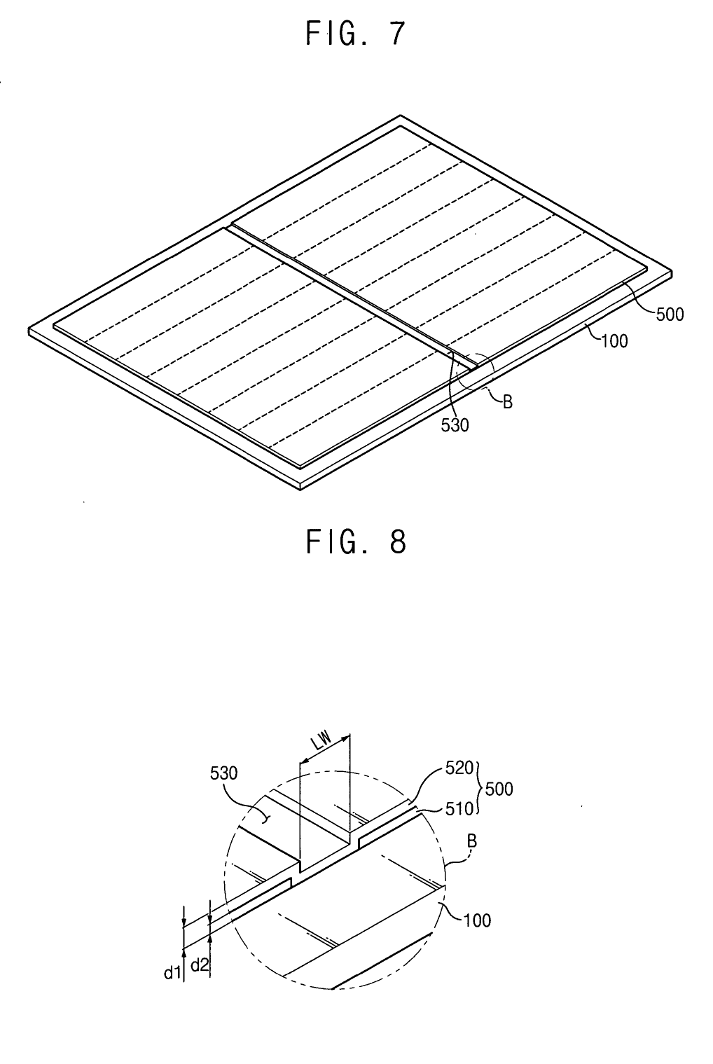

FIGS. 6 and 7 are perspective views showing the lower film shown in FIG. 1 according to alternative embodiments of the present invention and FIG. 8 is an enlarged view of a portion “B” shown in FIG. 7. In FIGS. 6 and 7, the dotted lines represent the location on which the sinking portions 220 (FIG. 1) are adhered.

Referring to FIG. 6, the first substrate 100 includes a lower film 400, which is formed on the first substrate 100 except on the areas on which the adhesive 110 is disposed and includes a plurality of connection passages 430. Although FIG. 6 shows the connection passages 430 having a linear shape, the connection passages 430 may have a rectangular shape or an elliptical shape as long as the connection passages 430 connect the adjacent discharge areas 210 (FIG. 2). Alternatively, the connection passages 430 cross either end of the sinking portions 220 (FIG. 1) in a longitudinal direction defining the sinking portions 220, and are arranged with a predetermined space therebetween. Each connection passage 430 is formed on the first substrate 100 by removing the portions of lower film 400 corresponding to the areas on which the ends of the sinking portions 220 are located partially or completely. Thus, the connection passages 430 have a smaller thickness than that of the other areas of the lower film 400. When the connection passages 430 are formed by completely removing the lower film 400, the connection passages 430 are formed to overlap the areas of the second substrate 200 (FIG. 1) on which the first and second electrode 240 or 250 (FIG. 1) is disposed.

Referring to FIGS. 7 and 8, the first substrate 100 includes a connection passage 530 in an effective emitting area of a lower film 500. The connection passage 530 linearly extends across the first substrate 100 and is formed on an area of the first substrate 100 corresponding to a location intermediate the ends defining the sinking portions 220 in a direction to a longitudinal direction defining each of the sinking portions 220. For example, the connection passage 530 is disposed on the area of the first substrate 100 corresponding to the middle of each of the sinking portions 220. Because the connection passage 530 is disposed apart from the first or second electrodes 240 or 250 disposed on the first or second substrate 100 or 200, charge drift can be prevented.

Since the connection passage 530 is formed within an effective emitting area, the connection passage 530, for example, is formed on the first substrate 100 on which a first fluorescent layer 520 is formed but a reflection layer 510 is absent. Thus, the thickness of the connection passage 530 has a thickness less than the total thickness (d1+d2) of the lower film 500, but greater than zero. For example, if the entire thickness of the lower film 500 is about 160 μm, the thickness of the connection passage 530 is about 60 μm to about 110 μm. In this case, when the line width (LW) of the connection passage 530 is about 0.5 μm to about 1 mm, the surface area of the connection passage 530 is (0.5 to 1)×(0.05 to 0.1)mm²

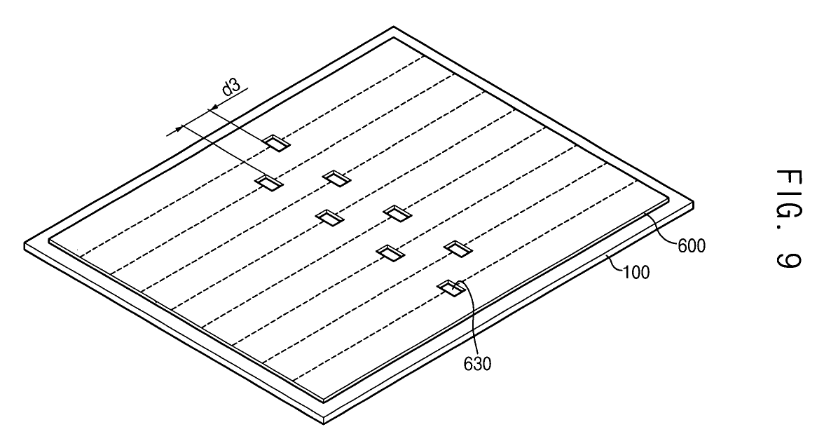

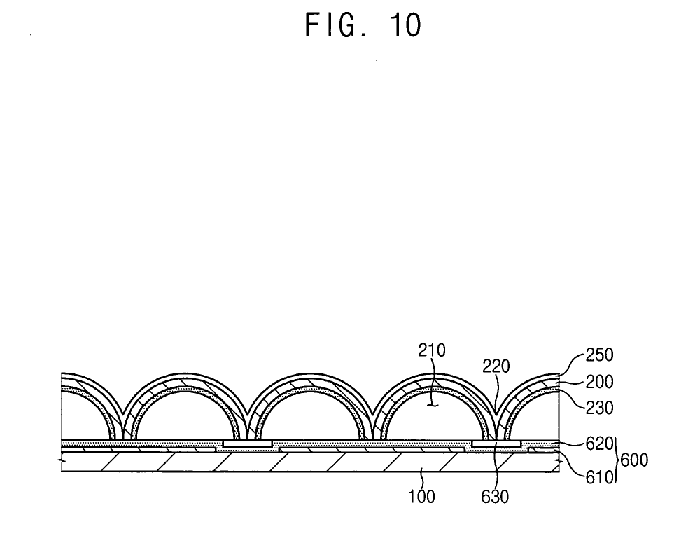

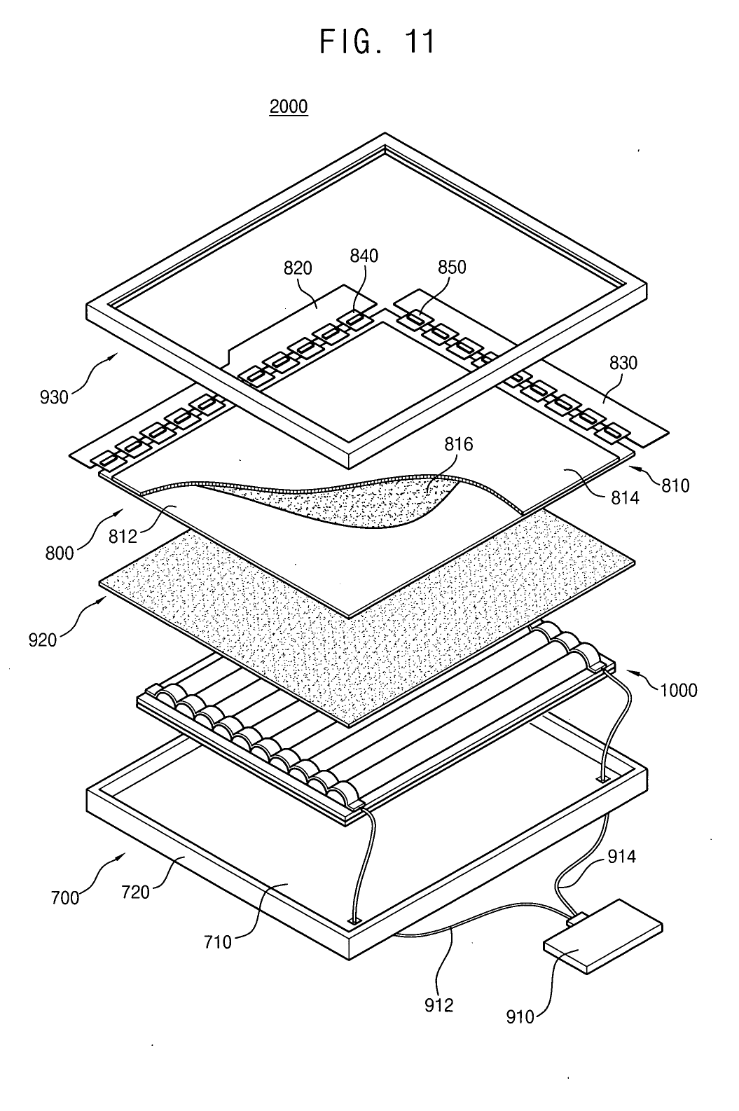

FIG. 9 is a perspective view showing the lower film shown in FIG. 1 according to another exemplary embodiment of the present invention, while FIG. 10 is a cross-sectional view of the lower film shown in FIG. 9.

Referring to FIGS. 9 and 10, the first substrate 100 includes a lower film 600, which is formed on the first substrate 100 except on the area on which the adhesive 110 is disposed, and includes a plurality of connection passages 630 formed on an effective emitting area. The connection passages 630 are formed on an area of the lower film 600 corresponding to the location intermediate the ends defining the sinking portions 220 in a direction to a longitudinal direction defining each of the sinking portions 220. For example, the connection passages 630 alternatively cross the adjacent sinking portions 220, and are disposed on the area of the lower film 600 corresponding to the middle of the sinking portions 220. The connection passages 630 are arranged with a predetermined distance (d3) therebetween, for example, about 10 mm to about 15 mm, on the lower film 600. Although FIG. 9 shows the connection passages 630 being a linearly shape, the connection passages 630 may have a rectangular shape or an elliptical shape as long as the connection passages 630 connect adjacent discharge areas 210 (FIG. 2).

Since the connection passages 630 are formed within an effective emitting area, the connection passage 630, for example, is formed on the first substrate 100 on which a first fluorescent layer 620 is formed but a reflection layer 610 is absent. Thus, the thickness of the connection passages 630 has a thickness less than the total thickness of the lower film 600, but greater than zero.

FIG. 11 is an exploded perspective view showing a LCD apparatus 2000 according to another exemplary embodiment of the present invention. In FIG. 11, the same reference numerals denote the same elements in FIGS. 1 and 2, and thus the detailed descriptions of the same elements will be omitted.

Referring to FIG. 11, the LCD apparatus 2000 includes a device for generating light 1000, a receiving container 700, and a display unit 800. The display unit 800 includes a LCD panel 810 to display images and date and gate PCBs 820 and 830 electrically connected to the LCD panel 810 through data and gate tape carrier packages 840 and 850. The data and gate PCBs 820 and 830 generate driving signals to drive the LCD panel 810.

The LCD panel 810 includes a thin film transistor (TFT) substrate 812, a color filter substrate 814 facing the TFT substrate 812, and liquid crystal 816 disposed between the TFT substrate 812 and the color filter substrate 814. The TFT substrate 812 includes a transparent glass substrate on which switching elements TFT (not shown) are arranged in a matrix configuration. The TFT includes a source electrode connected to a data line, a gate electrode connected to a gate line, and a drain electrode connected to a pixel electrode (not shown) of transparent conductive material. The color filter substrate 814 includes RGB pixels (not shown) and a common electrode (not shown) of a transparent conductive material. TFTs are turned on in response to a power applied to the gate electrodes thereof and an electric field is formed between the pixel electrodes and the common electrode. The electric filed changes the arrangement of the liquid crystals 816 disposed between the TFT substrate 812 and the color filter substrate 814, thereby changing the transmission of the light emitted from the device 1000 and displaying images having a desired gray scale.

The receiving container 700 includes a bottom surface 710 and side surfaces 720 perpendicularly extended from the edges of the bottom surface 710. The bottom surface 710 and the side surfaces 720 are formed together defining a receiving space to receive the device 1000. Because the device for generating light 1000 makes contact with the side surfaces 720, the separation of the device 1000 is prevented. The receiving container 700, although not shown in FIG. 11, may include an insulating member on the bottom surface 710 when the device for generating light 1000 includes electrodes disposed on the ends of the outer surface of the first substrate 100.

The LCD apparatus 2000 further includes an inverter 910, an optical member 920 and a top chassis 930. The inverter 910 is disposed under the receiving container 700 and generates a discharge voltage to drive the device 1000. The discharge voltage of the inverter 910 is applied to the first and second electrodes 240 and 250 (FIG. 1) of the device 1000 through first and second power lines 912 and 914.

The optical member 920 is disposed between the device for generating light 1000 and the LCD panel 810. The optical member 920 diffuses the light emitted from the device 1000 and further improves the uniformity of the brightness distribution of the light emitted from the device 1000. The optical member 920, for example, includes a diffusion sheet of a thin or thick sheet shape or a prism sheet to improve the brightness of light incident the LCD panel 810. The LCD apparatus 2000, although not shown in FIG. 10, may include a mold frame disposed between the optical member 920 and the device 1000 in order to support the optical member 920.

The top chassis 930 is coupled to the receiving container 700 while surrounding the edges of the LCD panel 810. The top chassis 930 protects the LCD panel 810 from an external impact and prevents the separation of the LCD panel 810 from the receiving container 700.

According to exemplary embodiments of the invention, a device for generating light includes a second substrate having at least one sinking portion and a first substrate having a lower film. The first and second substrates are adhered at peripheral facing surfaces of the first and second substrates, and the at least one sinking portion extends toward the lower film of the first substrate defining at least two discharge areas between the first and second substrates. The two discharge areas are communicated to each other by a connection passage formed on the lower film. Because the connection passage has a small size suitable to prevent charge drift between adjacent discharge areas, the device for generating light improves luminescence.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A device for generating light comprising:
a first substrate;
a second substrate assembled with the first substrate to form a discharge space between the first and second substrates, the second substrate including at least one sinking portion extending toward the first substrate to divide the discharge space into at least two discharge areas;
at least one connection passage formed on the first substrate to connect the discharge areas to each other; and
at least one electrode disposed on at least one of ends of an outer surface of the first substrate and ends of an outer surface of the second substrate in a direction substantially perpendicular to a longitudinal direction defining the at least one sinking portion.

2. The device of claim 1, wherein the at least one sinking portion extends in a first direction, and the at least one connection passage crosses at least one of ends defining the at least one sinking portion in a second direction substantially perpendicular to the first direction.

3. The device of claim 2, wherein the at least one connection passage includes a linear shape having a predetermined width.

4. The device of claim 1, wherein the second substrate includes a plurality of the sinking portions arranged with a predetermined space therebetween and extending in a first direction, the first substrate includes a plurality of the connection passages arranged with a predetermined space therebetween in a second direction substantially perpendicular to the first direction and alternatively crossing ends defining the sinking portions in the second direction.

5. The device of claim 4, wherein the connection passages include at least one of a linear shape, a rectangular shape and an elliptical shape.

6. The device of claim 1, wherein the at least one sinking portion extends in a first direction, the at least one connection passage crosses a location intermediate ends defining the at least one sinking portion in a second direction substantially perpendicular to the first direction.

7. The device of claim 6, wherein the at least one connection passage includes a linear shape having a predetermined width.

8. The device of claim 1, wherein the second substrate includes a plurality of the sinking portions arranged with a predetermined space therebetween and extending in a first direction, the first substrate includes a plurality of the connection passages arranged with a predetermined space therebetween in a second direction perpendicular to the first direction and alternatively crossing locations intermediate ends defining the sinking portions in the second direction.

9. The device of claim 8, wherein the connection passages include at least one of a linear shape, a rectangular shape and an elliptical shape.

10. The device of claim 1, wherein the first substrate further includes a lower film formed on the first substrate except on an area of the first substrate on which the at least one connection passage is formed.

11. The device of claim 10, wherein the lower film includes:
a reflective layer disposed on the first substrate except on an area of the first substrate on which the connection passage is formed configured to reflect light incident at the at least two discharge areas; and
a first fluorescent layer formed on the reflective layer configured to convert a violate ray into a visible ray.

12. The device of claim 11, wherein the second substrate includes a second fluorescent layer facing the first substrate, the second substrate converting the violate ray into the visible ray.

13. The device of claim 1, wherein the first substrate further includes a lower film having a thickness greater than a thickness of the connection passage.

14. The device of claim 13, wherein the lower film includes:
a reflection layer formed on the first substrate except on an area of the first substrate on which the connection passage is formed configured to reflect light incident at the at least two discharge areas; and
a first fluorescent layer formed on the first substrate on which the reflection layer is formed configured to convert a violate ray into a visible ray,
wherein the connection passage is formed on the first substrate on which the first fluorescent layer is formed.

15. The device of claim 14, wherein the second substrate includes a second fluorescent layer facing the first substrate, the second substrate converting the violate ray into the visible ray.

16. The device of claim 1, wherein the at least one connection passage overlaps the at least one electrode.

17. The device of claim 1, wherein the second substrate further includes at least two forming shapes, the at least one sinking portion being formed between the at least two forming shapes.

18. The device of claim 17, wherein the at least two forming shapes is formed by heating a plate glass substrate at a predetermined temperature and molding the glass substrate defining the at least two forming shapes on the glass substrate.

19. The device of claim 1, wherein the first and second substrate are assembled by adhering at a peripheral facing surfaces of the first and second substrates.

20. The device of claim 19, further comprising an adhesive disposed on the peripheral facing surfaces of the first and second substrates.

21. A liquid crystal display apparatus comprising:
a device for generating light including:
a first substrate;
a second substrate assembled with the first substrate to form a discharge space between the first and second substrates, the second substrate including at least one sinking portion extending toward the first substrate to divide the discharge space into at least two discharge areas;
at least one connection passage formed on the first substrate to connect the discharge areas to each other; and
at least one electrode disposed on at least one of ends of an outer surface of the first substrate and ends of an outer surface of the second substrate in a direction substantially perpendicular to a longitudinal direction of the at least one sinking portion;
a receiving container to receive the device for generating light; and
a liquid crystal display panel to display an image in response to the light emitted from the device for generating light.

22. The liquid crystal display apparatus of claim 21, wherein the at least one sinking portion extends in a first direction, and the at least one connection passage has a linear shape crossing at least one of ends defining the at least one sinking portion in a second direction substantially perpendicular to the first direction.

23. The liquid crystal display apparatus of claim 21, wherein the second substrate further includes a plurality of the sinking portions arranged with a predetermined space therebetween and extending in a first direction, the first substrate includes a plurality of the connection passages arranged with a predetermined space therebetween in a second direction substantially perpendicular to the first direction and alternatively crossing ends defining the sinking portions in the second direction.

24. The liquid crystal display apparatus of claim 21, wherein the first substrate further includes a lower film formed on the first substrate except on an area of the first substrate on which the at least one connection passage is formed.

25. The liquid crystal display apparatus of claim 24, wherein the lower film includes:
a reflective layer disposed on the first substrate except on an area of the first substrate on which the connection passage is formed configured to reflect light incident at the at least two discharge areas; and
a first fluorescent layer formed on the reflective layer configured to convert a violate ray into a visible ray.

26. The liquid crystal display apparatus of claim 25, wherein the second substrate includes a second fluorescent layer facing the first substrate, the second substrate converting the violate ray into the visible ray.

27. The liquid crystal display apparatus of claim 21, wherein the first substrate further includes a lower film having a thickness greater than a thickness of the connection passage.

28. The liquid crystal display apparatus of claim 27, wherein the lower film includes:
a reflection layer formed on the first substrate except on an area of the first substrate on which the connection passage is formed configured to reflect light incident at the at least two discharge areas; and
a first fluorescent layer formed on the first substrate on which the reflection layer is formed configured to convert a violate ray into a visible ray,
wherein the connection passage is formed on the first substrate on which the first fluorescent layer is formed.

29. The liquid crystal display apparatus of claim 28, wherein the second substrate includes a second fluorescent layer facing the first substrate, the second substrate converting the violate ray into the visible ray.

30. The liquid crystal display apparatus of claim 21, wherein the at least one connection passage overlaps the at least one electrode

31. A method for manufacturing a device for generating light comprising:
forming a first substrate;
forming a second substrate including at least one sinking portion;
adhering the first and second substrates at peripheral facing surfaces of the first and second substrates, wherein the at least one sinking portion extends toward the first substrate forming at least two discharge areas between the first and second substrates;
forming a connection passage on the first substrate to connect the at least two discharge areas to each other; and
disposing at least one electrode on at least one of ends of an outer surface of the first substrate and ends of an outer surface of the second substrate in a direction substantially perpendicular to a longitudinal direction defining the at least one sinking portion.

32. The method of claim 31, wherein forming a second substrate includes:
heating a plate glass substrate at a predetermined temperature; and
molding the grass substrate to define the at least one sinking portion on the glass substrate.

33. The method of claim 31, wherein forming a connection passage includes:
forming a reflection layer on the first substrate except on the peripheral facing surface of the first substrate, the reflection layer reflecting light incident the at least two discharge areas;
forming a first fluorescent layer on the reflection layer, the first fluorescent layer converting a violate ray into a visible ray; and
removing portions of the reflection layer and the first fluorescent layer on which the at least one connection layer is formed.

34. The method of claim 33, wherein forming a second substrate includes a second fluorescent layer facing the first substrate, the second substrate converting the violate ray into the visible ray.

35. The method of claim 31, wherein forming a connection passage includes:
forming a reflection layer on the first substrate except on the peripheral facing surface of the first substrate and on an area of the first substrate on which the at least one connection passage is formed, the reflection layer reflecting light incident the at least two discharge areas; and
forming a first fluorescent layer on the reflection layer and the area of the first substrate on which the connection passage is formed, the first fluorescent layer converting a violate ray into a visible ray.

36. The method of claim 35, wherein forming a second substrate includes a second fluorescent layer facing the first substrate, the second substrate converting the violate ray into the visible ray.

37. The method of claim 31, wherein the connection passage overlaps the at least one electrode.
